(19) United States
(12) Patent Application Publication
(10) Pub. No.: US 2004/0103933 A1
(43) Pub. Date: Jun. 3, 2004

(54) Paint gun washer

(76) Inventor: Pierre Mansur, Pinecrest, FL (US)

Correspondence Address: Robert M. Downey, ROBERT M. DOWNEY, P.A., Suite 300, 601 South Federal Highway, Boca Raton, FL, 33432, US

(21) Appl. No.: 10/719,494

(22) Filed: Nov. 21, 2003

Related U.S. Application Data
(60) Provisional application No. 60/428,978, filed on Nov. 22, 2002.

(51) Int. Cl. B08B 3/00

(52) U.S. Cl. 134/169 R; 134/84; 134/105; 134/108; 134/166 R

(57) ABSTRACT

A wash apparatus includes a tank for holding clean solvent, a first distillation chamber, a second distillation chamber and a washbasin surrounded by a closeable hood structure for cleaning paint spray guns and associated parts placed therein. The washbasin is selectively positionable in fluid circulating communication with either of the first and second distillation chambers during washing operations, wherein solvent discharged in the washbasin returns to the selected distillation chamber. When either of the distillation chambers becomes filled with contaminated solvent, the washbasin is operatively positioned in fluid circulating communication with the other distillation chamber for continued washing operations, thereby allowing the contaminated solvent in the filled distillation chamber to be purified during a distillation cycle. The purified solvent from the distillation cycle returns to the clean solvent holding tank.

This Application is based on previously filed Provisional Patent Application Serial No. 60/428,978 filed on Nov. 22, 2002. Applicant claims the benefit under Title 35, United States Code, Section 119(e) of the Provisional Patent Application filing date.

### BACKGROUND OF THE INVENTION

1. Field of the Invention

The present invention is directed to an apparatus for washing spray guns with a liquid solvent, and more particularly to an apparatus for washing paint spray guns and associated component parts with a liquid solvent and wherein the apparatus is structured for recycling the solvent to provide purified solvent for subsequent cleaning operations.

2. Discussion of the Related Art

Paint spray guns and associated component parts have long been used in various painting operations, such as in the automobile and marine industries. Typically, a paint spray gun assembly includes a hand held trigger actuated spray gun and a can or cup which attaches to the gun for holding a charge of paint to be supplied to the gun during the paint spraying operation. Delivery of paint to the gun may be through a siphon action or with the use of a pressurized air supply. After use of the spray gun and component parts during a particular painting job, the entire assembly, including the gun, cup and other associated component parts must be thoroughly cleaned of the paint which accumulates both on the interior and exterior surfaces of the equipment. Cleaning of the equipment is required not only to prevent mixing of colors, which would result in an undesirable color blend, but also to prevent buildup, blockage and jamming of the equipment. In a paint workshop, wherein painting operations are performed on a daily basis, the need to clean the spray gun equipment entails a great deal of time and expense. In some instances, it is required to clean the spray gun and associated component parts several times a day, particularly if the assembly is used with different paint colors.

In an attempt to minimize the time and expense associated with cleaning a large number of spray gun assemblies on a daily basis, various paint spray gun washers have been designed for circulating a cleaning fluid through a flow line system for ejection of the fluid under pressure within a closed cabinet. Examples of such systems can be found in U.S. Patents to Yamamoto, U.S. Pat. No. 4,785,836 and Robb et al., U.S. Pat. No. 4,793,369. More recent developments in the paint gun cleaning industry provide for recycling of the cleaning solvent. In particular, the U.S. Patent to Mansur, U.S. Pat. No. 5,388,601, discloses a spray gun washing apparatus which includes a cleaning chamber with solvent disbursing nozzles therein, a holding chamber for containing cleaning solvent and a distillation chamber for boiling the solvent in order to remove paint and other contaminants, thereby yielding purified cleaning solvent for subsequent use. During operation, the solvent is circulated from the holding chamber and out through the solvent disbursing nozzles in a continuous flow cycle, wherein partially contaminated solvent, containing paint and other residues, is pumped through valves and conduits for release, under pressure, from the disbursing nozzles in the cleaning chamber.

The present invention provides for an efficient, simplified paint gun washer apparatus which provides purified cleaning solution throughout each cleaning operation. More specifically, the paint gun washer of the present invention eliminates the need to pump contaminated solvent from a holding chamber through valves, conduits and various fittings, thereby eliminating problems such as valve malfunctions and clogs as a result of residue buildup. Moreover, use of side by side distillation chambers allows for cleaning operations to be performed over one distillation chamber while simultaneously purifying solvent in the adjacent distillation chamber during a distillation cycle. Use of a heat resistant resistant residue containment bag in the distillation chamber allows for ease of cleaning and disposal after the distillation.

### SUMMARY OF THE INVENTION

The present invention is directed to an apparatus for washing paint spray guns and associated parts. The apparatus includes a tank for holding clean solvent, a first distillation chamber, a second distillation chamber and a washbasin surrounded by a closeable hood structure for washing the paint spray guns and associated parts therein. The washbasin is selectively positionable in fluid circulating communication with either of the first and second distillation chambers. In a preferred embodiment, the washbasin is moveable in relation to the distillation chambers to be selectively positioned over a sealable access opening on the top of either distillation chamber. During washing operations, solvent pumped from the first distillation chamber is discharged from jet nozzles within the washbasin and returns to the first distillation chamber. A final rinse operation pumps clean solvent from the holding tank to a spigot in the washbasin for manual rinsing of the paint spray gun and parts.

When the first distillation chamber becomes filled with contaminated solvent, the washbasin is moved into fluid circulating communication with the second distillation chamber for continued washing operations. During a distillation cycle, the first distillation chamber is sealed closed and the contaminated solvent is heated to separate clean solvent vapors from the contaminants. The solvent vapors are then directed to a condenser to yield pure solvent that is directed to the holding tank.

### BRIEF DESCRIPTION OF THE DRAWINGS

For a fuller understanding of the nature of the present invention, reference should be made to the following detailed description taken in conjunction with the accompanying drawings in which:

FIG. 1 is an exploded perspective view illustrating the principal component parts of the paint gun washer apparatus of the present invention, in accordance with a preferred embodiment thereof;

FIG. 2 is a top, front perspective view of the paint gun washer apparatus;

FIG. 3 is an isolated cross-sectional view illustrating a moveable vertical solution pick-up tube for connecting the washbasin in fluid circulating communication with either of the distillation chambers;

FIG. 4 is an isolated perspective view, showing one of the two distillation chambers of the paint gun washer apparatus, and an associated cover latch mechanism for holding the top lid and access cap of the distillation chamber in a closed, sealed position;

FIG. 5 is an isolated side elevational view illustrating one embodiment of the slide mechanism for slidably coupling the washbasin to the base housing of the paint gun washer apparatus; and

FIG. 6 is a side elevational view of the paint gun washer apparatus, shown schematically to illustrate the principal components thereof.

Like reference numerals refer to like parts throughout the several views of the drawings.

### DETAILED DESCRIPTION OF THE PREFERRED EMBODIMENT

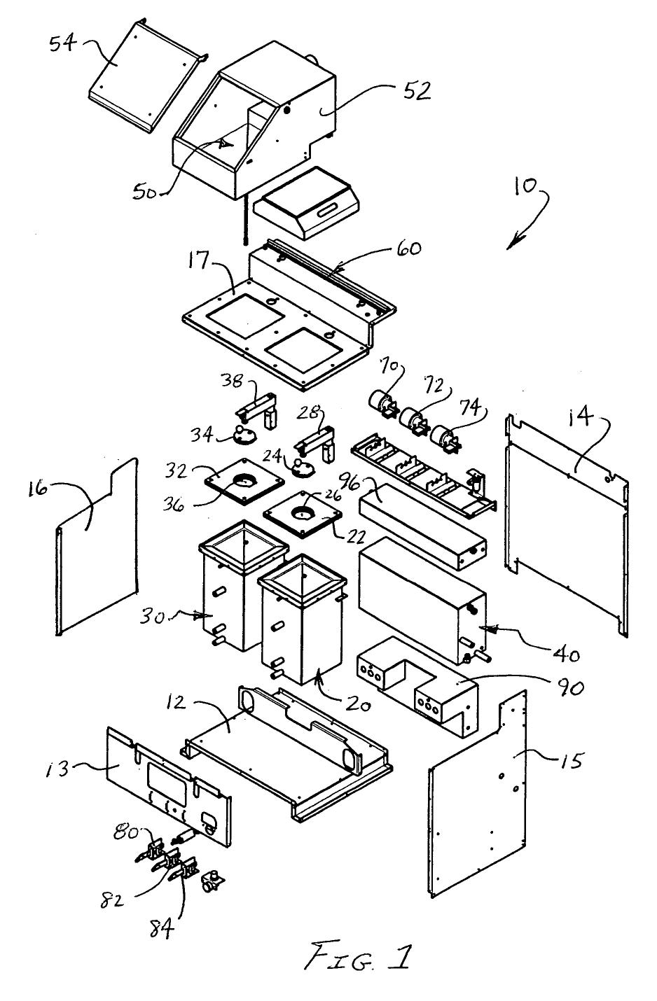

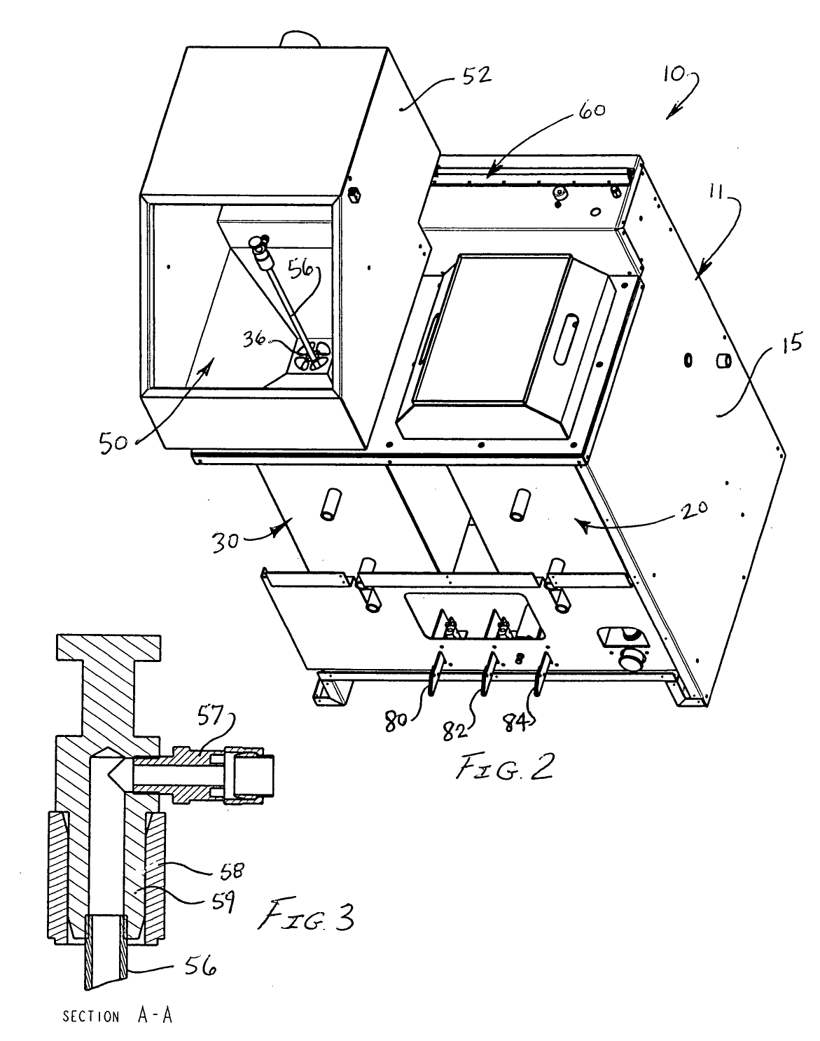

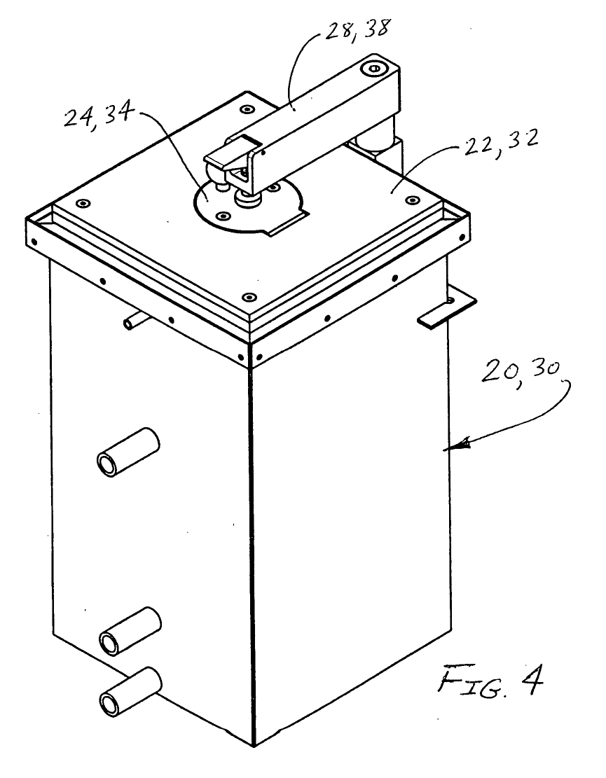

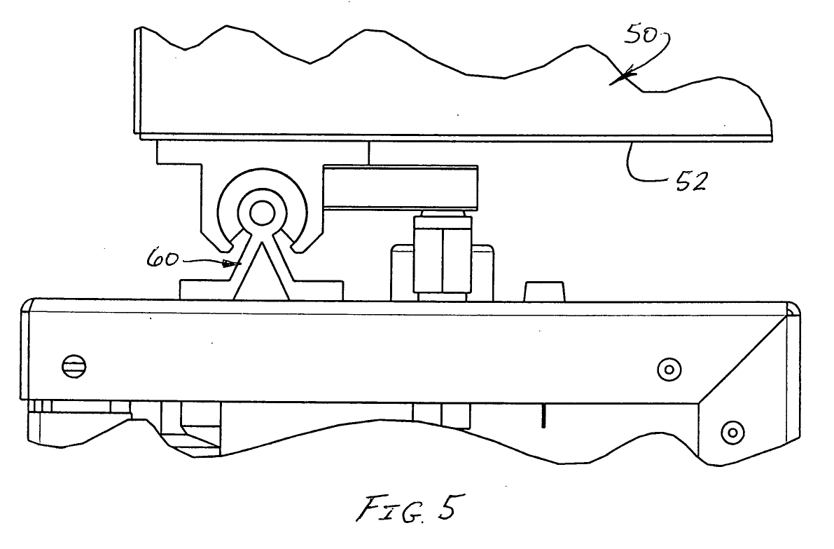

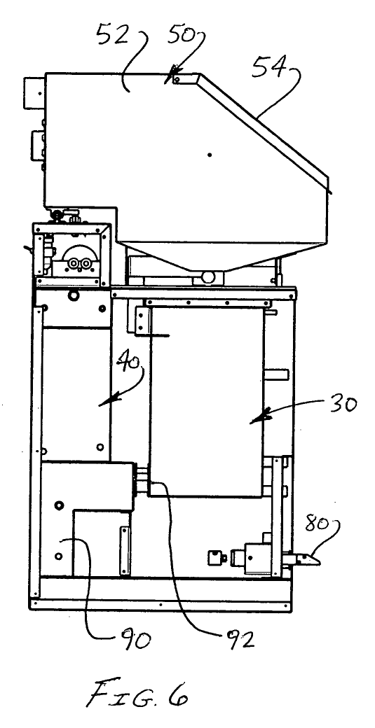

Referring to the several views of the drawings, and initially FIGS. 1-3, the paint gun washer apparatus is shown in accordance with various embodiments thereof and is generally indicated as 10.

The paint gun washer apparatus 10 includes a main base unit comprising an arrangement of components contained within a housing 11. The housing 11 includes a bottom 12, a front wall 13, a rear wall 14, opposite side walls 15, 16 and a top plate 17. In a preferred embodiment, the housing is formed of a sheet metal such as steel or aluminum. However, the particular material and manner of construction of the housing may be in accordance with various known or newly discovered techniques and, therefore, is not intended to be limited by the instant disclosure.

The paint gun washer apparatus 10 is provided with two separate distillation chambers, including a first distillation chamber 20 and a second distillation chamber 30, each contained within the housing 11. The distillation chambers 20, 30 are each provided with respective top lids 22, 32 which are removably fitted to an open top of the distillation chambers in sealed attachment therewith. Each lid 22, 32 is provided with an access door 24, 34 respectively, for covering a corresponding access opening 26, 36 in the lid. Means such as an O-ring are provided for sealing the access doors 24, 34 closed when covering the respective openings 26, 36. An associated cover latch 28, 38 is provided on each of the respective distillation chambers 20, 30 for holding the top lids 22, 32 and access doors 24, 34 in the sealed, closed position. The cover latches 28, 38 are structured to lock down so that they apply a downward force on the access doors 24, 34 and lids 22, 32.

A clean solvent holding tank 40 in the housing 11 holds a supply of clean solvent, such as mineral spirits, for use to remove paint and other contaminants from the paint spray guns and component parts which are cleaned within a washbasin 50. The washbasin 50 is provided with a surrounding hood structure 52 and an access door 54 for containing the paint spray gun and component parts therein during washing operations. The access door 54 can be left open during manual rinsing operations. During a timed automatic cleaning cycle, the access door 54 is closed to contain the sprayed solvent and contaminants within the washbasin.

The washbasin 50, including the enclosing hood structure 52, is moveably coupled to the base unit housing 11 on a slide mechanism 60. In a preferred embodiment, the slide mechanism 60 is comprised of the combination of a rail extending transversly on the top of a back, raised portion of the base unit and a congruently configured channel on the underside of the washbasin. The rail is received in the channel and allows the channel and washbasin to slide relative to the rail and base unit housing. The slide mechanism 60 allows the washbasin 50 to be moved into operative position in fluid circulating communication with either the first distillation chamber 20 or the second distillation chamber 30. When operatively positioned with one of the distillation chambers, the washbasin 50 is in alignment with the respective top lid 22 or 32 of the selected distillation chamber. More specifically, a hole or opening in the bottom of the washbasin 50 is aligned with the access opening 26, 36 of the respective distillation chamber 20, 30. A solvent pick-up conduit is then extended down through the access opening and into the respective distillation chamber. In one embodiment, the solvent pick-up conduit is in the form of a rigid tube 56 which is vertically moveable to extend down through the access opening 26 or 36 of the operatively positioned distillation chamber. The rigid vertical tube 56 is held within a coupling 58 and sealed by O-rings 59 or other seal means. A solvent supply tube 57 connects to the coupling 58 for fluid flow communication with the vertical tube 56 for directing solvent from the tube 56 to one or more pumps in order to circulate the solvent during the wash operation.

In a preferred embodiment, a plurality of pneumatic pumps 70, 72 and 74 are provided for circulating solvent during wash operations. Each pump 70, 72 and 74 is selectively actuated by depressing an associated foot pedal 80, 82 and 84. An external pressurized air supply (not shown) connects to the apparatus 10 and supplies pressurized air for operating the pumps 70, 72 and 74.

Electronics for controlling operation of heaters 92 and other components during a timed wash cycle and distillation cycle are contained with a purged control box 90. The control box 90 is connected to the external pressurized air supply to maintain the control box free of volatile vapors. The purged electronics control box is a safety feature to isolate the electronics from potentially explosive vapors by maintaining the interior of the electronics control box at a higher pressure than the surrounding ambient air pressure using pressurized air from the external air supply.

The heaters 92 heat contaminated solvent within the distillation chambers 20, 30 during a distillation cycle, to produce solvent vapors which separate from paints and other contaminants. The separated solvent vapors are then directed to a condenser 96 where the vapors are condensed to yield pure liquid solvent. The purified solvent is then directed into the holding tank 40 for subsequent use.

Operation of the paint gun washer apparatus, according to three phases of operation, is described as follows:

1. Initial Start-Up:

The apparatus 10 is plugged into a wall outlet electric supply and is further connected to an external pressurized air supply such as an air compressor. The sliding washbasin 50 is pushed to either the extreme left position or extreme right position of its travel, thereby exposing the top lid of one of the distillation chambers while the washbasin is positioned over the lid of the other distillation chamber. The exposed distillation chamber lid is then removed to permit cleaning of the distillation chamber. In a preferred embodiment, each distillation chamber 20, 30 is fitted with a heat resistant residue containment bag (e.g. a nylon material bag) for ease of cleaning. In this instance, the opened distillation chamber is fitted with a new residue containment bag which is placed into the distillation chamber and secured in proper position. The top lid 22 or 32 of the exposed distillation chamber is then closed and the sliding washbasin 50 is then moved over the previously exposed distillation chamber, with the access door remaining open, so that the opening in the bottom of the washbasin aligns with the access opening of the distillation chamber which has been cleaned (e.g. by removing the old residue containment bag within and replacing with a new residue containment bag) as described above. Once the washbasin is positioned over the clean and empty distillation chamber, the solvent pick-up conduit 56, 56′ is pushed down through the access opening of the distillation chamber and into the distillation chamber (i.e. into the residue containment bag therein). A primer fill of clean solvent, sufficient to cover the bottom open end of the solvent pick-up conduit 56, 56′, is initiated by depressing the third foot pedal 84. This activates pneumatic pump 74 to pump clean solvent from the holding tank 40 and out from a spigot within the washbasin 50 which subsequently drains into the correspondingly aligned distillation chamber. Once the bottom end of the solvent pick-up tube 56, 56′ is submerged below the level of clean solvent within the distillation chamber, the washer apparatus 10 is ready for use in the paint gun cleaning operation.

2. Paint Gun Cleaning Operation:

A three-stage wash operation is initiated by depressing the correct foot pedal 80, 82 or 84 in accordance with a particular sequence. By depressing the first foot pedal 80, pump 70 is actuated to circulate solvent from within the distillation chamber and up through the solvent pick-up conduit 56. The solvent is then directed out through a small spigot in the washbasin, allowing the operator to manually rinse the paint spray gun and associated component parts in order to remove heavy accumulations of paint and other contaminants. The contaminated solvent then returns through the access opening on the top of the distillation chamber, by gravity, and into the distillation chamber. In the preferred embodiment, the contaminated solvent returns directly into the residue containment bag within the distillation chamber.

Next, the second pedal 82 is depressed one time after both the paint spray gun and an associated canister are placed over jet nozzles within the washbasin and the access door 54 is closed. This activates an automatic high-pressure rinse cycle using the second pump 72 to draw the contaminated solvent through the solvent pick-up tube 56 and through the pump 72 where it is forcibly discharged out from the jet nozzles within the washbasin. This is a fully automatic, timed cycle once the foot pedal 82 is depressed. The contaminated solvent returns through the access opening 26 or 36 of the respective distillation chamber, by gravity flow, so that the contaminated solvent fills back into the distillation chamber (e.g. the residue containment bag).

Once the automatic solvent wash cycle is complete, the operator opens the access door 54. The third pedal 84 can then be selectively depressed to pump clean solvent from the holding tank 40 and out through a separate spigot in the washbasin 50, allowing a final clean solvent manual rinse of the paint spray gun and associated component parts. The pure solvent discharged from the spigot obviously becomes contaminated once used in the final clean rinse of the paint spray gun and is returned by gravity through the access opening of the distillation chamber directly into the distillation chamber (e.g. the residue containment bag).

The paint spray gun and associated component parts are now clean and ready for reuse. Accordingly, the paint spray gun and component parts are removed from the washbasin and can be wiped dry with a clean rag.

3. Distillation Cycle:

Use of the solvent during the wash cycles, as described above, accumulates within the distillation chamber operatively aligned in fluid circulating communication with the washbasin. This is due to both the final clean solvent rinse, which adds to the amount of solvent in the distillation chamber, as well as the accumulation of spent paint left within the paint spray gun. When the distillation chamber (e.g. residue containment bag) becomes filled to capacity with contaminated solvent, paint and other contaminants, the distillation chamber needs to be emptied and cleaned. To do this, the operator pulls the solvent pick-up conduit 56 up through the access opening 26 or 36 of the respective distillation chamber and into the washbasin 50 to allow the washbasin 50 to slide to either the extreme left or extreme right position. This positions the washbasin over the other distillation chamber which should be empty and clean at this stage. The clean distillation chamber, having been previously cleaned (e.g. fitted with a new residue containment bag) is ready for use. Accordingly, when the washbasin 50 is moved over the clean distillation chamber, the solvent pick-up conduit 56 is lowered down into the clean distillation chamber. Again, the operator initiates use of the clean distillation chamber by discharging an initial charge of clean solvent, from the clean solvent holding tank 40, into the distillation chamber to cover the end of open end of the solvent pick-up conduit 56. This is accomplished by operating the third foot pedal 84. The repositioned washbasin is now ready for use in continued wash operations.

The exposed distillation chamber, which is filled with contaminated solvent from subsequent wash operations, is emptied and cleaned according to the following operation:

First, the top lid and access door on the top of the distillation chamber are closed and locked down, using the respective cover latch mechanism 28 or 38. An exposed start button is then pushed to initiate the distillation cycle. This triggers operation of the heaters 82 to heat and slowly boil the contaminated solvent within the distillation chamber, creating vapors which separate from contaminants and pass through the cooled condenser 96. The vapors are then condensed to yield purified liquid solvent which is directed back into the holding tank 40 for reuse.

Once the distillation of contaminated solvent within the distillation chamber is complete, and the distillation chamber has had time to cool, the operator removes the dirty residue containment bag, containing paint residue solids and other contaminants that were separated during the distillation process. A new, clean residue containment bag is replaced in the distillation chamber. The cleaned distillation chamber is now ready for subsequent use once the other distillation chamber becomes filled to capacity with contaminated solvents.

While the instant invention has been shown and described in accordance with preferred and practical embodiments thereof, it is recognized that departures from the instant disclosure are contemplated within the spirit and scope of the present invention.

What is claimed is:

1. An apparatus for cleaning paint spray gun assemblies, comprising:
a holding tank for holding a supply of clean solution;
a first distillation chamber including an access opening;
a second distillation chamber, including an access opening;
a wash basin moveably supported on said apparatus and adapted to be selectively positionable in fluid transferring communication with either of said first and second distillation chambers;
a pump for delivering the clean solution from said holding tank to said wash basin for discharge therein, wherein solution discharged into the wash basin returns to the selected distillation chamber positioned in fluid transfer communication with said wash basin;
heaters associated with each of said first and second distillation chambers for heating contaminated solution contained therein in order to produce vapors and separate contaminants; and
a condenser for condensing the vapors to yield purified solution, said condenser being disposed in fluid communication with said holding tank for directing the purified solution to said holding tank.

2. The apparatus as recited in claim 1 wherein said washbasin is moveable for selective alignment with the access opening of either of said first and second distillation chambers so that solution discharged into the washbasin is directed through the access opening and into the respective distillation chamber selectively positioned in fluid transfer communication with the wash basin.

3. The apparatus as recited in claim 1 further comprising:
access doors for selectively covering and sealing closed the access openings of said first and second distillation chambers.

4. The apparatus as recited in claim 1 further comprising:
a second pump for circulating the solution from either of said first or second distillation chambers and to said wash basin for discharge therein.

5. The apparatus as recited in claim 1 wherein said wash basin includes a hood structure and closeable access door for surrounding and enclosing the washbasin in order to contain sprayed cleaning solution, contaminants and vapors during cleaning of the paint spray gun assemblies placed within the wash basin.

6. The apparatus as recited in claim 4 wherein said wash basin includes a hood structure and closeable access door for surrounding and enclosing the washbasin in order to contain sprayed cleaning solution, contaminants and vapors during cleaning of the paint spray gun assemblies placed within the wash basin.

7. The apparatus as recited in claim 6 wherein said second pump is operable for a timed wash cycle to thereby discharge the solution into said wash basin, under pressure, during the timed wash cycle.

8. The apparatus as recited in claim 1 wherein said wash basin is moveable supported on a transverse rail.
